(19) United States
(12) Patent Application Publication
(10) Pub. No.: US 2026/0135768 A1
(43) Pub. Date: May 14, 2026

(54) SYSTEMS AND METHODS FOR AUTOMATED NETWORK TROUBLESHOOTING

(71) Applicant: Verizon Patent and Licensing Inc., Basking Ridge, NJ (US)

(72) Inventors: John F Moore, Philadelphia, MS (US); Ravneet K Pharwaha, Highland, NY (US); Venkata K Manthena, Santa Clarita, CA (US); Douglas Salemi, Denville, NJ (US); Nageswara R Tanuku, Hopewell Junction, NY (US)

(21) Appl. No.: 18/947,026

(22) Filed: Nov. 14, 2024

(51) Int. Cl. H04L 41/142; H04L 41/0631

(52) U.S. Cl. CPC H04L 41/142; H04L 41/065

(57) ABSTRACT

One or more computing devices, systems, and/or methods for automated network troubleshooting are provided. Data, associated with operation of a network, is retrieved and converted into a series of Boolean values. The series of Boolean values are interpreted to identify issues associated with the network. The issues may be grouped into clusters, and root causes are assigned to the clusters. An action for resolving a root cause of an issue is executed such as by providing task instructions to a user for issue resolution, an automated work flow, an action executed from a machine learning model, or a closed loop automation routine.

### BACKGROUND

Many businesses automate tasks, workflows, and processes in order to improve operations and reduce costs. For example, a retail business may implement a chat bot through a retail website. The chat bot may be configured to provide automated responses to user questions submitted through the chat bot. The chat bot may utilize machine learning models, decision trees, and/or other functionality to generate the responses. The chat bot may automatically generate service tickets for issues to troubleshoot. Automation may be used for a wide variety of other use cases, such as troubleshooting problems, order processing, communicating with customers, executing workflows and tasks, etc.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for automated network troubleshooting, where a recommendation is generated, in accordance with an embodiment of the present technology;

FIG. 2 illustrates an example of a method for automated network troubleshooting, in accordance with an embodiment of the present technology;

FIG. 3A illustrates an example of a system for automated network troubleshooting, where an action is performed, in accordance with an embodiment of the present technology;

FIG. 3B illustrates an example of network insights, keys, and clusters, in accordance with an embodiment of the present technology.

FIG. 3C illustrates an example of decoding definitions, in accordance with an embodiment of the present technology.

FIG. 4 illustrates an example of a system for automated network troubleshooting, where a record flattening function is implemented, in accordance with an embodiment of the present technology;

FIG. 5 illustrates an example of a system for automated network troubleshooting, where a network diagnostic engine is implemented, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for automated network troubleshooting. A network, such as a cellular network, includes cell towers, radio access network equipment, and/or other network equipment that provides user equipment with voice, data, and/or other communication services over the network. Operational information, key performance indicators, system logs, and/or other information may be collected from the network equipment, network probes, and user equipment as part of the data, such as network data. The data can be vast and depending on the network node, may result in tens of thousands of transactions per hour. Due to the verbosity of data, it is a standard practice to filter records to reduce data computation and storage by downstream systems. For example, if a cell tower experiences a service degradation, then that cell tower may experience an increased dropped call rate above a predetermined threshold. The standard approach is to filter the data to only include only the most important information while most of the record details are discarded. Retaining the data could provide valuable insights that a network operator can use to provide better customer experience. However, due to vast amounts of data required, it is usually considered cost prohibitive. Due to the sheer amount of information, manual review is either impossible (e.g. data may be collected from millions of devices) or impractical (e.g. a customer service representative cannot review thousands of system logs during a live troubleshooting call), and thus automation is used to evaluate the data for identifying and resolving issues.

The disclosed automated network troubleshooting technique improves upon conventional data retrieval, storage, and automation techniques by converting the data into network insights. Network insights are a single statement about the customer's experience that is either true or false. As an example, a subscriber may experience 10 dropped calls while using a cell tower that was experiencing a service disruption. This generates ten system logs (data) that contain the details of each dropped call confirming they were caused by the service disruption. It may be assume that the customer's dropped calls were caused by the service disruption. Therefore, a network insight can be created as a single Boolean value. The 10 system logs for each dropped call can be discarded. The system simply creates a single Boolean value that can be decoded and interpreted into the network insight appropriately.

Many network insights could be true or false at the same time. Using traditional techniques, all the relevant data is stored and is subsequently retrieved when troubleshooting occurs. The data is evaluated using a decision tree, and a root cause is determined. Using the disclosed approach, this can be skipped because all the relevant troubleshooting information was already stored as network insights. All the network insights are assigned to a hierarchy and stored in a logical sequence called a data key. A network insight is a logical representation of a specific experienced by a customer at a specific time. The data key is a series of Boolean values which represent every network problem a customer experienced at a specific period of time (a 1 hour period of time), and each issue is organized based on priority. As mentioned previously, the original data is no longer needed once the data key is generated, and the original can be discarded to conserve storage space. System efficiencies are gained because the data key is only a few bytes, which requires significantly less data storage and compute resources to process by downstream systems.

In addition, multiple data keys can be logically grouped into many clusters. A cluster may be a grouping of data keys that provide useful business information. In some embodiments, a data key may represent all the network issues a subscriber experienced for a given hour, while a cluster represents all the issues a customer experienced over a week. In some embodiments, a cluster can be created to represent all the customers who had the same network experience during the service disruption. In some embodiments, clusters can be used to identify all customers who require a specific troubleshooting action, such as a software update, to be performed. This results in operational efficiency gains because it is possible to address customer issues in bulk rather than individually. Clusters are not limited to being customer based, but can be applied to any dimension which is retained during data collection. In addition, clusters are not limited to troubleshooting, but can be used for business analytics, reporting, or trending.

Instructions for how to resolve a root cause of an issue may be generated along with relevant metadata. The instructions may be automatically executed to resolve the issue, or may be provided to a customer or an agent helping the customer resolve the issue. Because the disclosed automated network troubleshooting technique can efficiently process the Boolean values without utilizing complex decision tree logic, network troubleshooting can be efficiently scaled for bulk processing and proactive use cases (e.g., millions of troubleshooting routines may be performed daily, as opposed to being limited to thousands of troubleshooting routines using traditional methods). In some embodiments, an issue may relate to a network element such as a cell tower that drops calls more than a threshold (e.g., more than threshold number of dropped calls within a particular timespan). Accordingly, an alert/alarm may be created with a recommendation to execute a troubleshooting routine. In some embodiments, when a customer calls with an issue, the pre-generated Boolean values can be used to inform a customer service representative of a potential network issue in the customer's area. This reduces the customer interaction time and increasing the volume of trouble ticket intake. Also, auto resolution can be performed to reduce the volume of incoming trouble tickets.

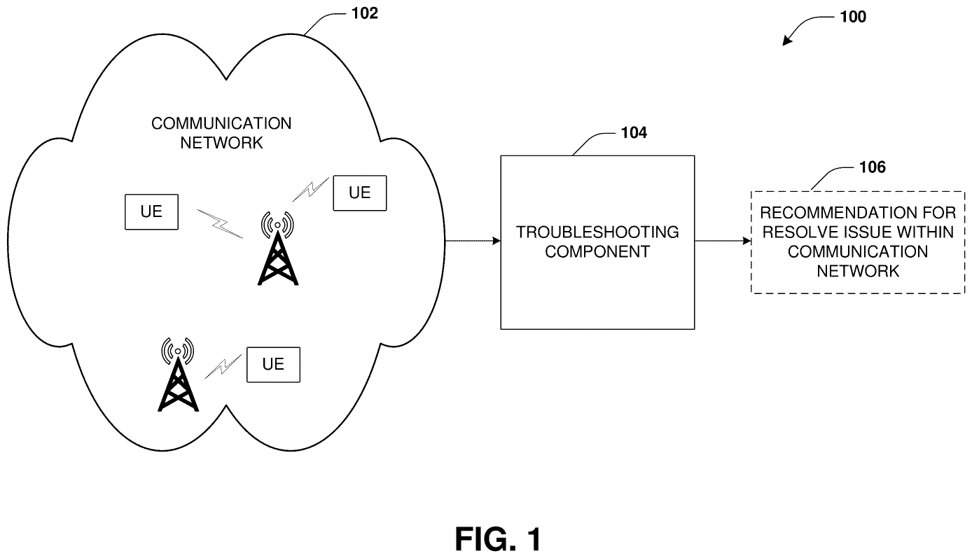

FIG. 1 illustrates an example of a system 100 for automated network troubleshooting. A network 102 may provide user equipment with data, voice, and/or other communication capabilities over the network 102. For example, a cell phone may utilize the network 102 for placing/receiving phone calls, sending/receiving text messages, accessing services, etc. The user equipment can experience various issues such as dropped calls, problems sending/receiving text messages, an inability to access voicemail, a slow data connection, and/or a variety of other issues. Network equipment of the network 102, such as base stations, cell towers, and other types of network equipment, may experience issues that can cause a network outage or degraded performance for the user equipment.

A troubleshooting component 104 may perform automated network troubleshooting to identify issues and perform actions to help resolve the issues. In some embodiments, the troubleshooting component 104 may proactively identify issues and resolutions through periodic monitoring of the data, such as network data, communication data, or other types of data. Issues are detected proactively in two ways. Top down detection occurs when a network issue is found via a threshold violation and a list of subscriber's are found with the corresponding network insight being set to true. For example, a cell tower may exceed a predetermined dropped call rate of 10%. The system retrieves a list of all the users who have the network insight for ‘call drops due to cell degradation’=true. The list of impacted subscribers is shared with the system of engagement platform to address any customer complaints that result from the service disruption. This approach is proactive because analysis and troubleshooting is performed before customer contact. The subscribers may merely be informed of the findings and may be provided with status updates. The bottoms up approach occurs when a threshold violation occurs based on the network insight previously collected. A cluster is automatically created, network engineers are notified, and troubleshooting begins. For example, 1,000 distinct customers had the ‘call drops due to cell degradation’=true on a specific cell tower during a specific hour. No known network alarms of service disruptions are detected on the cell tower mentioned. A network ticket is automatically generated and engineers are engaged. The list of subscribers is shared with the system of an engagement platform to inform customers that an investigation is underway due to a possible service disruption in their area.

In some embodiments, the troubleshooting component 104 may reactively (on-demand) identify issues and resolutions based upon a troubleshooting request. The troubleshooting component 104 performs the automated network troubleshooting by converting data into a series of Boolean values. The data may relate to download speed, upload speed, dropped calls, connectivity statistics, data usage statistics, key performance indicators, operational information of network equipment or user equipment, etc. The troubleshooting component 104 evaluates network insights, data keys, and clusters to identify issues, such as where user equipment has experienced dropped calls, an inability to access voicemail, failed text message transmission, slow data transmission, etc. over a particular timespan.

The troubleshooting component 104 groups the issues into clusters based upon similarities amongst the issues (e.g., dropped call issues occurring during a particular time span for user equipment connected to the same cell tower). The groups are dynamic and can be created based on any of the data collected. In addition, the groups can be used for other purposes such as reporting. The troubleshooting component 104 assigns a root cause to each of the clusters based upon the issues within the clusters. A root cause assigned to a cluster corresponds to a cause of an issue represented by the cluster, such as where a base station failure is a root cause of dropped call issues grouped into the cluster. The troubleshooting component 104 may generate and provide a recommendation 106 for resolving the issue, such as instructions for how to address the root cause of the issue. In some embodiments, the recommendation may be provided to a user experiencing the issue. In some embodiments, the recommendation 106 may be provided to an agent troubleshooting the issue for a customer. In some embodiments, the troubleshooting component 104 may perform an action to resolve the issue, such as by sending a command over the network 102 to reset or reconfigure the base station. In this way, the troubleshooting component 104 can proactively and/or on-demand (reactively) identify and help resolve issues within the network 102.

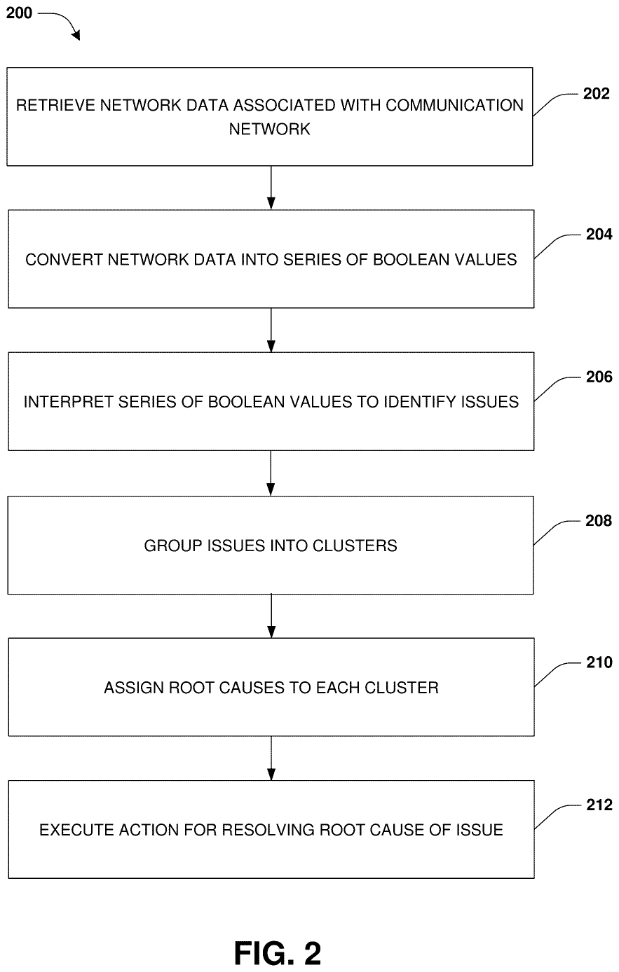

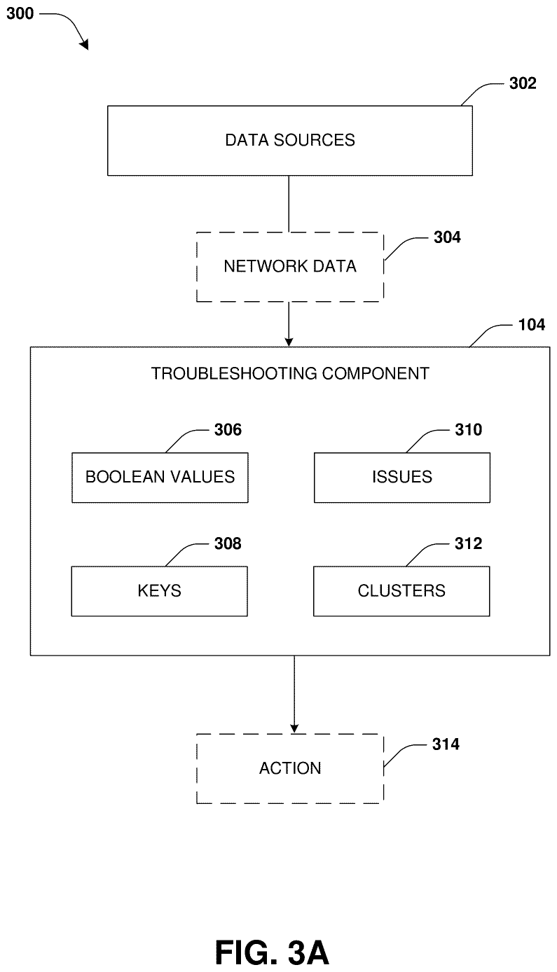

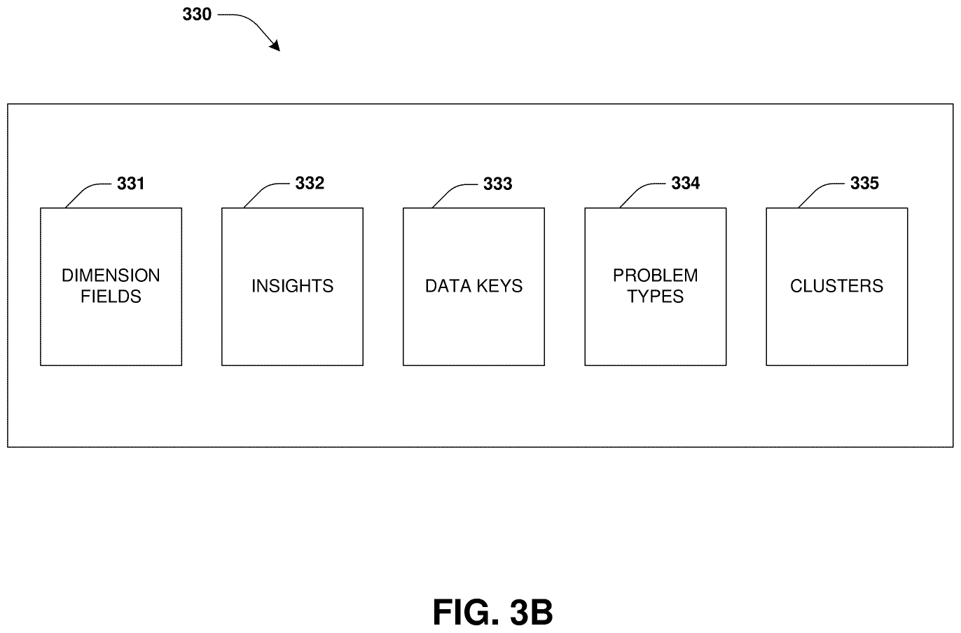

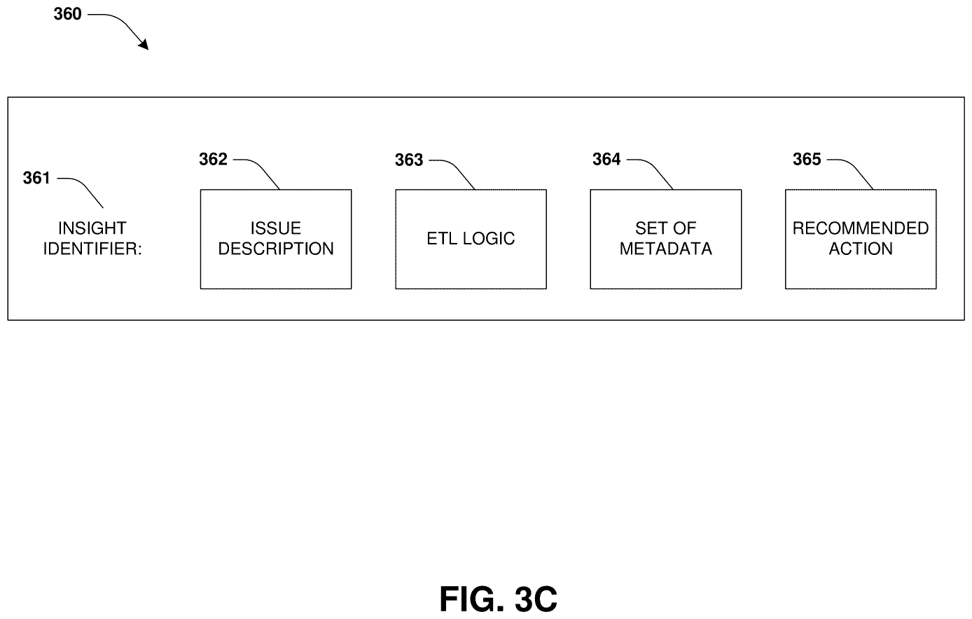

FIG. 2 illustrates an example of a method 200 for automated network troubleshooting, which is described in conjunction with system 300 of FIG. 3A. Data 304 may be collected from various equipment within a network, and may be stored in data sources 302. The equipment may relate to network equipment (e.g., cell towers, repeaters, base stations, antennas, etc.), user equipment (e.g., cell phones, tablets, laptops, smart devices, Internet of Things devices, servers, smart watches, etc.), and/or other devices. The data 304 may relate to operational statistics of the devices, such as download speed, upload speed, dropped calls, text message errors, connection strength, network equipment failure, degraded performance, etc.

Various issues can arise within the network, such as where user equipment experiences dropped calls, slow download rates, an inability to send/receive text messages, problems accessing voicemail, network equipment failures, etc. When a user reports a problem, manual efforts to troubleshoot the problem can be time consuming, and often there is no immediate resolution such as where there is a network outage due to an equipment failure that affects numerous customers. Thus, automated troubleshooting can be performed to automatically identify and/or resolve issues within the network. However, conventional automated troubleshooting relies on complex decision tree logic that consumes a significant amount of computing resources and time to identify issues and potential solutions for the issues, and thus the amount of troubleshooting that can be performed within a day is limited. These limitations and inefficiencies of conventional automated troubleshooting are overcome by the disclosed troubleshooting component 104 that can more efficiently identify issues and solutions with less compute, resource consumption, and time so that a greater amount of troubleshooting routines can be performed (e.g., millions of daily troubleshooting routines instead of thousands per day).

The troubleshooting component 104 may proactively identify issues and potential solutions such as on a periodic basis, and/or may on-demand identify issues and potential solutions such as in response to a troubleshooting request. During operation 202 of method 200, the troubleshooting component 104 retrieves data 304 from the data sources 302, such as from a database, a cloud storage environment, user equipment, network equipment, etc. During operation 204 of method 200, the troubleshooting component 104 converts the data 304 into network insights values 306. A network insight represents whether a condition is met or not during a time span. For example, a network insight for a dropped call condition of a smartwatch will have a first value (e.g., “True,” “Yes,” or “1”) if the data 304 indicated that the smart watch experienced a dropped call during a 1 hour timespan. The network insights for the dropped call condition of the smartwatch will have a second value (e.g., “False,” “No,” or “0”) if the data 304 indicated that the smart watch did not experience a dropped call during a 1 hour timespan.

FIG. 3B illustrates a chart 330 of network insights related to various conditions such as a cannot originate any phone calls condition, a data slow speeds condition, and/or other conditions. The chart 330 may include dimension fields 331 that can be used to query data, such as Data, mobile directory number (MDN), EventID, etc. Dimensions can be queried differently to obtain different clusters. The chart 330 may include insights that are single Boolean values that represent a fact about a customer's experience, and are broken down into symptoms (e.g., a customer has 10 dropped calls) and causes (e.g., a customer experienced an outage). The chart 330 may include data keys 333 (keys) that are a combination of insights for a data/time period, such as an hour (e.g., a single row of insights in a table/chart 330). The data keys 333 are logically constructed such that the more critical issues are organized from left to right where the left most insight along the row is the most important factor/issue to address first. The chart 330 may include problem types 334 that are a section of data type that refer to a specific issue that a customer may experience (e.g., dropped calls, slow speeds, etc.). The problem types 334 are also organized from left to right based upon priority such as where unable to connect has a higher priority than slow speeds. The chart 330 may include clusters that are the entire table and are determined based upon the dimensions (dimension fields) that are queried. A cluster represents symptoms can causes over a period of time, which may be combined into a total column. Unlike a data key where insights will be addressed from left to right along a row based upon their priority, the cluster may have some insights that are less important, but occur more frequently. Accordingly a network diagnostic engine interprets the outcome to make a decision on which insight is given priority to address.

The network insights and/or conditions may relate to root causes (RCs) that are either identified as occurring or not (e.g., at least one call failed to complete in a network; at least one call that was routed for treatment; an announcement message was played; etc.), which is further described by chart 360 of FIG. 3C. The chart 360 describes decode definitions for when a root cause is identified for a network insight, and a recommended action to suggest or automatically execute (e.g., create a ticket indicating a detected failure in an IMS core). The issues may be prioritized from the worst issues on the left to the least worst issues on the right, and thus the first occurring issue from left to right on a row (e.g., a root cause having a value of “1”) has a highest priority to troubleshoot first. Each insight has an identifier that maps to additional information, such as insight identifier 361 that is mapped to an issue description 362 used by downstream applications, extract, transform, and load (ETL) logic 363 that evaluates network records to determine if the insight is true or false, a set of metadata 364 of supporting information for downstream applications, and/or a recommended action 365 to fix an issue.

In some embodiments, a key may be generated based on network data collected and organized into a set of the Boolean values 306 associated with a particular customer, issue, network equipment, timeframe, or some other network insight for the network. In some embodiments, keys (data keys) may be created for each hour or other timespan, such as keys relating to customer voice delay, customer voice real-time, customer data delay, customer data real-time, cell tower specific insights such as for eNB/gNB, and EventID specific to network outages, which are used to troubleshoot, notify customers, and perform reporting. In particular, keys 308 may be formed based upon combinations of Boolean values corresponding to certain network insight. For example, the keys 308 can be generated on a per customer basis, a per issue basis, a per network equipment basis, a per timeframe basis, or any other basis. Each row of the chart 330 includes a series of Boolean values that may represent a key (e.g., a data key corresponding to any issues that occurred for a customer over an hour). A key may be evaluated to identify an issue and/or root cause of the issue based upon the conditions represented by the Boolean values used to generate the key (e.g., was there a dropped call, slow download speed, connectivity issue, voicemail access issue, text message issue, etc.). For example, a combination of one or more keys 308 (e.g., a key related to a cell tower, keys related to user equipment connected to the cell tower, keys related to a timeframe during which the user equipment experienced dropped calls, etc.) may be evaluated to determine a root cause of an issue.

During operation 206 of method 200, the troubleshooting component may interpret the series of Boolean values 306, such as the keys 308, to identify issues 310 associated with the network. For example, if the series of Boolean values 306 indicate that user equipment had dropped calls over a particular timespan, then a dropped call issue for the user equipment may be identified. During operation 208 of method 200, the issues 310 may be grouped into clusters 312 based upon similarities of the issues 310 (e.g., dropped call issues may be grouped into a cluster; text message issues may be grouped into a cluster; low signal issues may be grouped into a cluster; etc.). In some embodiments, issues may be grouped together into a cluster based upon the issues corresponding to a same root cause, network equipment, and/or timeframe.

During operation 210 of method 200, root causes may be assigned to the clusters. A root cause assigned to a cluster may correspond to a cause of an issue represented by the cluster (e.g., a base station upgrade may be the root cause of dropped calls for user equipment near the base station during a time span of the upgrade / unavailability of the base station). In some embodiments of determining the root cause, network insights may be generated based upon the series of Boolean values (e.g., network insight indicating the customers in a certain location are experiencing dropped calls). The network insights may be labeled as either a symptom (e.g., a dropped call) or a cause (e.g., a base station upgrade may be a cause of the symptom of the dropped call). The root cause may be determined based upon the network insights and labels, such as where a root cause may relate to a cause of a symptom.

In some embodiments of determining the root cause, a hierarchy may be applied to the issues 310 and the clusters 312 to determine the root cause. In some embodiments, the hierarchy may be applied to the issues 310 and the clusters 312 to assign the issues to task instructions for issue resolution. That is, a particular issue such as voicemail access issues may be associated with troubleshooting and resolution task steps that can be performed for potentially resolving the voicemail access issues. The task instructions may be provided to a customer and/or a service agent helping troubleshoot a voicemail access issue experienced by the customer. In some embodiments, actions may be proactively performed such as before a customer has reported a problem. In some embodiments, an action for resolving a root cause of an issue is executed such as by providing task instructions to a user for issue resolution, an automated work flow, an action executed from a machine learning model, or a closed loop automation routine

In some embodiments, each data key (key) has sections for each problem type. A problem type is a similar set of insights related to a specific customer problem, such as a dropped call issue. The problems are organized in priority order based on importance (e.g., unable to connect has a highest priority, then an issue that affects services such as a cell outage, and less important issues would be poor audio quality or slow speed). The insights themselves are organized in priority order from left to right within each problem type (e.g., for unable to connect, an insight that a customer did not pay their bill might have a higher priority than an outage). Downstream applications can merely address each issue in the order the issues appear in a string because the issues are sorted/occur according to the priority ordering/importance, which may be performed when dealing with real-time data and an hour timespan is of interest. With a cluster, the diagnostic engine interprets the data because timing may be a factor. A customer may have a less important issue, but the issue occurs more frequently or the customer is submitting an issue request about a small issue that is occurring now/recently compared to a major issue from a week ago. Thus, the priorities can be dynamically changed based upon such timing factors, what prompted a user to reach out for assistance, thresholding (e.g., do not create a service ticket unless slow speeds have occurred for at least 24 hours), and thus different recommendations can be provided by the logic within the diagnostic engine.

During operation 212 of method 200, the troubleshooting component 104 may execute an action 314 for resolving the root cause of the issue. In some embodiments, the action 314 pertains to generating a recommendation for how to resolve the root cause. The recommendation may be populated with task instructions that can be performed by a user or service agent troubleshooting an issue on behalf of the user. The recommendation may specify priorities for the issues to resolve, such as where a network outage should be resolved before a dropped call issue because the network outage is likely a cause of the dropped call issue (dropped calls may be a symptom of the network outage).

In some embodiments, the action 314 may relate to performing automated issue resolution such as where a command is transmitted over the network to a device (e.g., a command to reconfigure the device, restart the device, modify operation of the device, retrieve additional information from the device, etc.). In some embodiments, the action 314 is executed to trigger a workflow (e.g., a workflow to create and/or process a service ticket for troubleshooting an issue). In some embodiments, the action 314 is executed to update a map, displayed to a user through a user interface, with a visual indicator of an issue (e.g., an indicator/marker may be displayed on the map to indicate a location of an outage). In some embodiments, the action 314 is executed to automatically process and/or close out a service ticket (e.g., task instructions may be automatically executed to process the service ticket to resolution without manual intervention). In some embodiments, the action 314 is executed to send a message to a customer about an issue. In some embodiments, the action 314 is executed to generate a report describing issues, root causes of the issues, symptoms, causes of the symptoms, affected user equipment, network equipment that has failed or is operating in a degraded mode, etc. In some embodiments, the action 314 is executed to perform crowd sourced troubleshooting such as where if enough user equipment are experiencing issues within a certain location over a particular timespan, then the issues may be troubleshot together.

In some embodiments, the troubleshooting component 104 may periodically retrieve and convert new data into series of Boolean values that are stored as information within a data store. The information within the data store may be processed for identifying issues, root causes, and/or triggering execution of actions and workflows.

In some embodiments, a condition trigger may be applied to the series of Boolean values 306 (e.g., a condition where a threshold number of user equipment connected to a base station are experiencing low signal quality) to trigger issue identification and clustering for assigning an issue identification identifier to an identified issue to resolve. The issue identification identifier (e.g., a field name) may be used to provide instructions for performing an automated troubleshooting process for the identified issue. In some embodiments, network insights are logically grouped together. For example, there may be 25 network insights related to the inability to place a phone call to any number, and are thus logically grouped together (e.g., group as a cannot originate problem type). A logical issue identification process evaluates the 25 insights to decide whether a cannot originate problem type issue should be set of true (e.g., set a Boolean value associated with an inability to original phone calls to any number). If the cannot originate problem type issue, then various actions can be performed such as providing a prompt customer calls for troubleshooting assistance. The prompt may indicate that the customers should run a troubleshooting routine for resolving issues related to placing phone calls even if the customers do not mention the problem. This can be proactively used such as by selecting a percentage of customers having the worse issue to run troubleshooting scripts for potentially fixing the problem via automation (e.g., automation run as a nightly job). The problem type (e.g., the cannot originate problem type) is used as an indicator to the system for which script to run.

In some embodiments, a request for on-demand issue identification may be received by the troubleshooting component 104 (e.g., a customer service agent, a chat bot, creation of a service ticket, user submission through a help form, or other function may trigger the request). Accordingly, the troubleshooting component 104 may identify the root cause and execute the action 314 to generate a response for the request with instructions for resolving the root cause.

In some embodiments, the keys 308 are formed based upon combinations of the Booleans values 306. Operation of network equipment (e.g., a cell tower, base station, etc.) may be evaluated based upon a subset of the keys 308 corresponding to the network equipment and user equipment connected to the network equipment. For example, the subset of the keys 308 may correspond to Boolean values specifying whether conditions are met or not for the network equipment and the user equipment. The subset of the keys 308 may be evaluated to identify issues and/or root causes of issues related to operation of the network equipment such as where a failure or degraded performance of the network equipment has affected the user equipment. In some embodiments, the keys 308 and/or combinations of the Boolean values 306 may be evaluated to identify a network equipment issue. Records associated with user equipment connected to the network equipment may be updated to specify that the network equipment is a user equipment issue condition (e.g., failure or degraded performance of the network equipment is a condition, such as a potential cause, of an issue that could be experienced by the user equipment).

In some embodiments, the keys 308 and/or combinations of the Boolean values 306 may be evaluated to detect a customer issue, such as a slow download speed issue. In some embodiments, the keys 308 and/or combinations of the Boolean values 306 may be evaluated to identify a plurality of user equipment with issues during a timeframe. Network equipment may be identified as having a network equipment issue based upon the plurality of user equipment being connected to or attempting to connect to the network equipment during the timeframe. In this way, the troubleshooting component 104 may automatically identify issues and/or potential solutions for the issues.

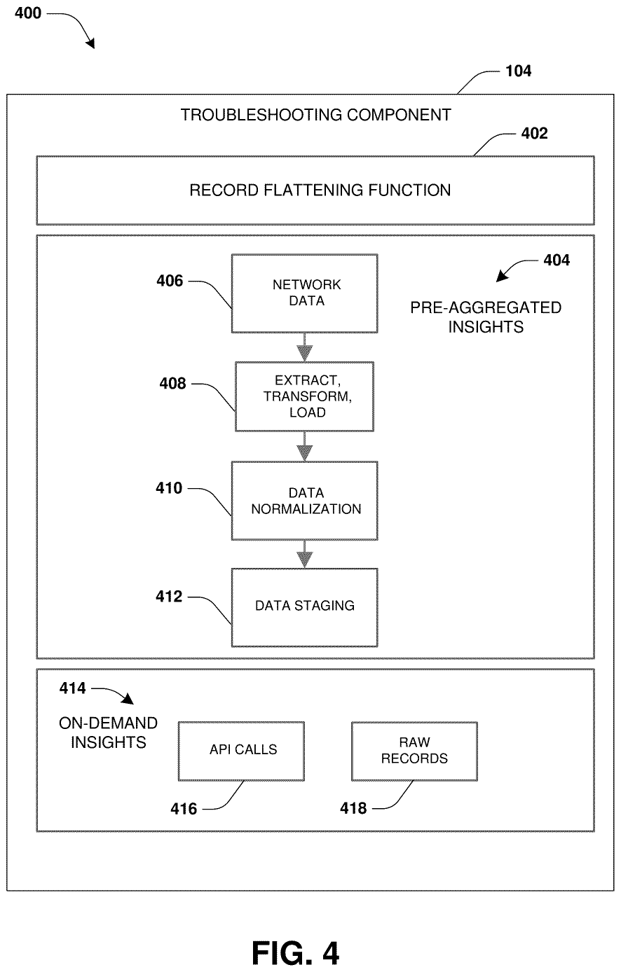

FIG. 4 illustrates an example of a system 400 for automated network troubleshooting, where a record flattening function 402 is implemented. The system 400 may include the troubleshooting component 104. The troubleshooting component 104 may implement the record flattening function 402 in order to generate and store Boolean values and/or keys representing combinations of the Boolean values.

The record flattening function 402 may perform pre-aggregated insights functionality 404. The pre-aggregated insights functionality 404 includes retrieving data 406. The pre-aggregated insights functionality 404 includes extraction (e.g., extracting information from the data 406 that is relevant for issue identification), transformation (e.g., transforming the extract information into a format suitable for storage within a database), and loading 408 of the information into the database for processing. The pre-aggregated insights functionality 404 includes data normalization 410. The data normalization 404 implements logic to create fields with the Boolean values, such as using logical expressions (e.g., dropped call=True when . . . ; slow download speed=Yes when download speed less than 15 Mbps; voicemail access failure=1 when . . . ; etc.). In some embodiments, True and Yes are represented by 1 or some other value, and False and No are represented by 0 or some other value. During data normalization 410, the information stored in the database is interpreted to create Boolean values, such as 0s and 1s that are stored by data staging 412 for subsequent evaluation for issue identification and resolution. The Boolean values may represent conditions that were True (1) or False (0) over a timespan such as over an hour. In some embodiments, the Boolean values are used as fields to create keys that are stored by data staging 412 for subsequent evaluation for issue identification and resolution.

On-demand insights 414 may be implemented to perform API calls 416 to retrieve additional data (e.g., raw records 418) on-demand as needed to fill in any gaps (e.g., missing information needed by the data normalization logic to determine whether a condition is True or False). In this way, the data 406 is converted into Boolean values for issue and root cause identification, troubleshooting, and/or resolution.

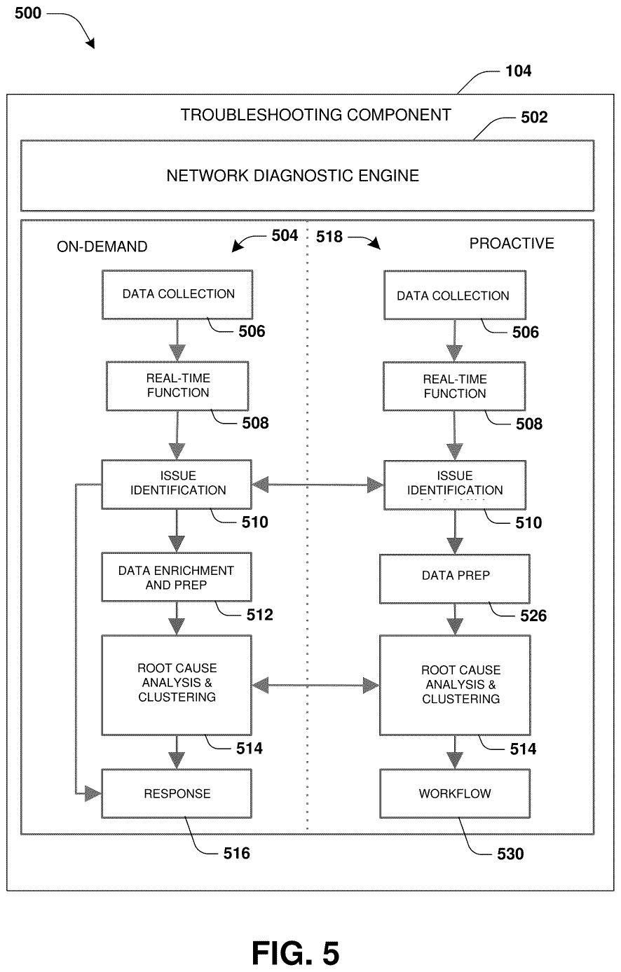

FIG. 5 illustrates an example of a system 500 for automated network troubleshooting. The system 500 includes the troubleshooting component 104 that implements a network diagnostic engine 502 that proactively 518 and/or on-demand 504 processes the Boolean values and/or keys staged by the record flattening function 402 of FIG. 4. As part of the network diagnostic engine 502 implementing the on-demand processing 504 such as in response to receiving an API call, data collection 506 is performed to retrieve the Boolean values that may be represented as combinations of field values populated within keys. A key may correspond to field values populated with the Boolean values that represent a particular set of related conditions, such as conditions of user equipment connected to a base station during a particular timeframe. The network diagnostic engine 502 implements a real-time function 508 to perform real-time processing while data is being loaded (e.g., Boolean values, keys, etc.). The data may be evaluated differently based upon different use cases. In some embodiments, with real-time processing, merely a single real-time data key is used to detect whether a customer is part of a current outage, along with an EventID for the outage. In some embodiments, if a customer calls with all the issues experienced over the past week, then a cluster is obtained and the diagnostic engine is used to evaluate real-time and delayed data keys, which may merge keys.

The real-time processing is performed because a response 516 is being generated on-demand in real-time, such as in response to the API call. Certain outages may necessitate a faster response than other checks/issues. If system (e.g., an external system such as an alarming platform) sends a notification, outage details can be store into a data key record so that the outage details are quickly available. Different systems produce data with different amounts of latency, and thus timing is an issue if all data is waited for. Accordingly, two different data keys are created for each hour, a real-time key of currently available real-data and a delayed key for when data becomes available.

The network diagnostic engine 502 implements issue identification 510 to identify issues based upon the Boolean values (keys). The issue identification 510 evaluates combinations of field values of the keys to identify/generate issues being experienced by customers, such as symptoms (e.g., call quality issues, dropped calls, slow speeds, etc.). The network diagnostic engine 502 may optionally implement data enrichment and/or preparation 512 such as by retrieving any additional data/information needed to identify root causes of the issues (symptoms).

The network diagnostic engine 502 performs root cause analysis and clustering 514. The conditions, symptoms, causes, and/or issues are used to group the issues into clusters, and root causes are assigned to the clusters. For example, similar issues may be clustered together (e.g., dropped call issues of user equipment connected to a particular base station), and a root cause such as a failure or degraded performance of the base station may be identified as a root cause of the issues within the cluster. The network diagnostic engine 502 outputs a response 516 of the root cause, information about the issues, task instructions for issue resolution, etc.

The network diagnostic engine 502 may perform the proactive issue identification and/or resolution 518, such as on a periodic basis (e.g., hourly). The proactive issue identification and/or resolution 518 may include the data collection 506, the real-time function 508, and/or issue identification 510. The proactive issue identification and/or resolution 518 may include data preparation 526, such as where the data is prepped/formatted for root cause analysis and clustering 514 that is performed as part of the proactive issue identification and/or resolution 518. Once a root cause is identified for one or more issues, a workflow 530 may be automatically executed, such as to send a notification to a customer, process a service ticket, close a service ticket, send a command over the network to network equipment to modify operation of the network equipment, etc.

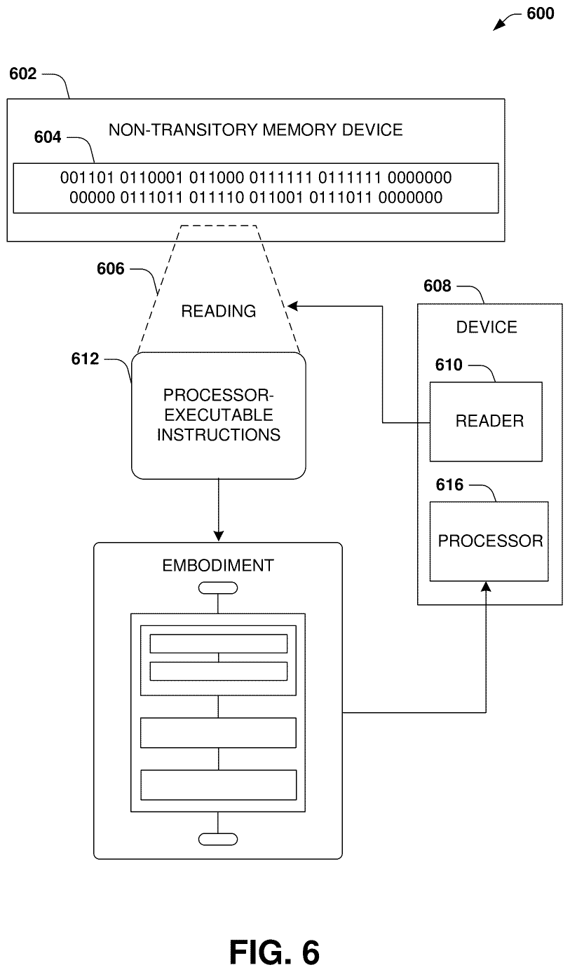

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1, at least some of the example system 300 of FIG. 3A, at least some of the example system 400 of FIG. 4, and/or at least some of the example system 500 of FIG. 5, for example.

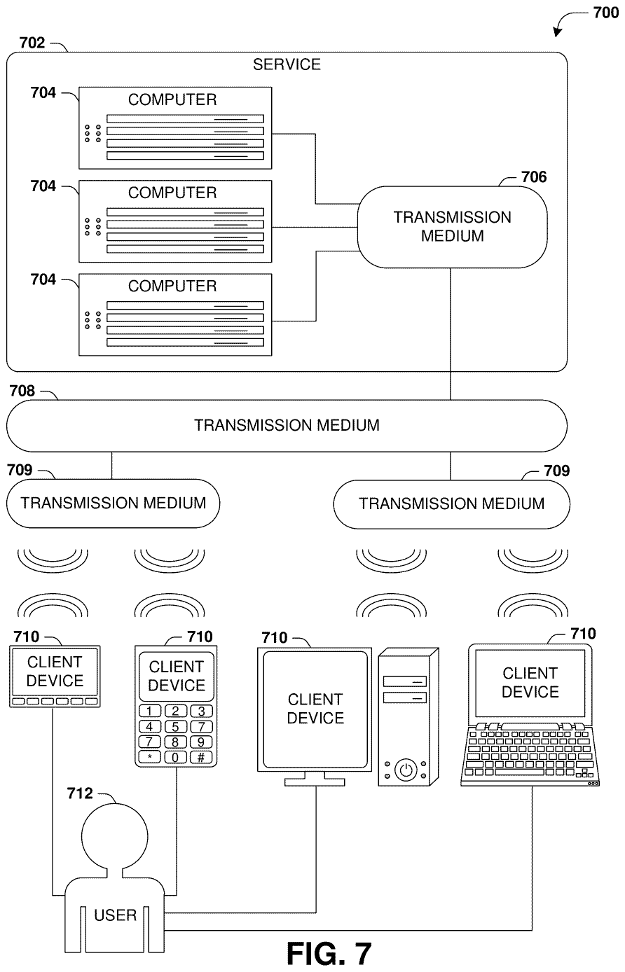

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

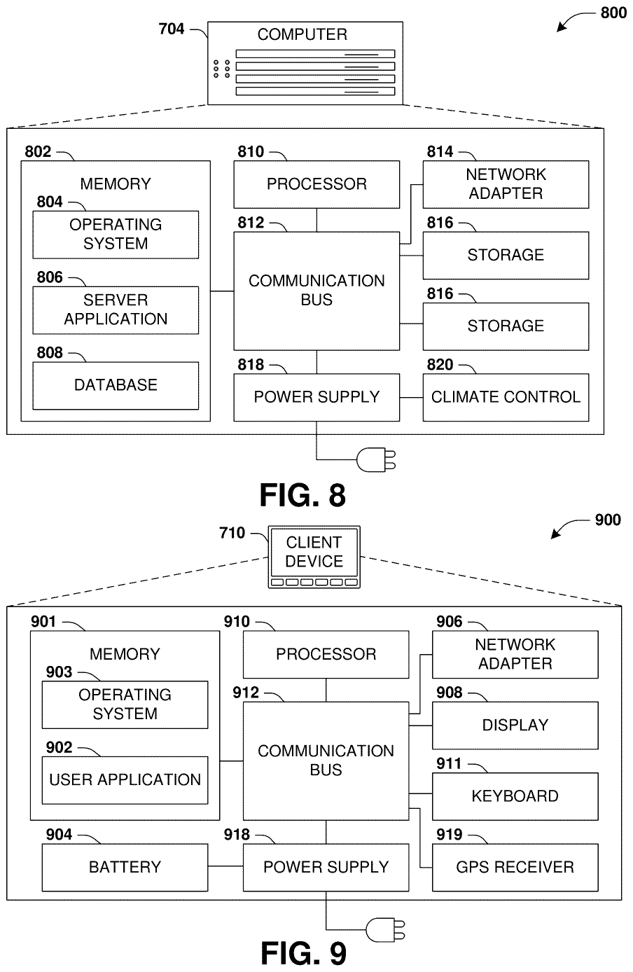

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
retrieving data associated with operation of a network;
converting the data into a series of Boolean values, wherein a Boolean value represents whether a condition is met or not;
interpreting the series of Boolean values to identify issues associated with the network;
grouping the issues into clusters based upon similarity of the issues;
assigning root causes to each of the clusters, wherein a root cause assigned to a cluster corresponds to a cause of an in issue represented by the cluster; and
executing an action for resolving the root cause of the issue.

2. The method of claim 1, further comprising:
generating a key based upon a set of Boolean values representing network insight for the network; and
evaluating the key to identify the issue.

3. The method of claim 1, wherein executing the action further comprises:
generating task instructions for issue resolution; and
providing the task instructions to a user to perform.

4. The method of claim 1, wherein the network is a communications network, further comprising:
generating network insights based upon the series of Boolean values;
labeling network insights as either a symptom or a cause; and
determining the root cause based upon the network insights and labels.

5. The method of claim 1, wherein the grouping further comprises:
grouping issues together into the cluster based upon the issues corresponding to a same root cause, network equipment, and timeframe.

6. The method of claim 1, further comprising:
applying a hierarchy to the issues and the clusters to determine the root causes.

7. The method of claim 1, further comprising:
applying a hierarchy to the issues and the clusters to assign the issues to task instructions for issue resolution.

8. The method of claim 1, wherein the data is network data and further comprising:
periodically retrieving and converting new network data into a plurality of series of Boolean values stored as information within a data store; and
processing the information within the data store to trigger execution of a workflow.

9. The method of claim 1, further comprising:
applying a condition trigger function to the series of Boolean values to trigger issue identification and clustering for assigning an issue identification identifier for an identified issue to resolve; and
utilizing the issue identification identifier to provide instructions for performing an automated troubleshooting process for the identified issue.

10. The method of claim 1, further comprising:
in response to receiving a request for on-demand issue identification, identifying the root cause and executing the action to generate a response for the request with instructions for resolving the root cause.

11. A system, comprising:
one or more processors configured for executing instructions to perform operations comprising:
retrieving data associated with operation of a network;
converting the data into a series of Boolean values, wherein a Boolean value represents whether a condition is met or not;
interpreting the series of Boolean values to identify issues associated with the network;
grouping the issues into clusters based upon similarity of the issues;
assigning root causes to each of the clusters, wherein a root cause assigned to a cluster corresponds to a cause of an in issue represented by the cluster; and
executing an action for resolving the root cause of the issue.

12. The system of claim 11, wherein the operations further comprise:
forming keys based upon combinations of Boolean values; and
evaluating combination of the keys to determine the root cause.

13. The system of claim 12, wherein the forming further comprises:
forming the keys on at least one of a per customer basis, a per issue basis, a per network equipment basis, or a per timeframe basis.

14. The system of claim 11, wherein the operations further comprise:
forming keys based upon combinations of Boolean values; and
evaluating operation of network equipment based upon a subset of the keys corresponding to the network equipment and user equipment connected to the network equipment.

15. The system of claim 11, wherein the operations further comprise:
evaluating combinations of Boolean values to detect a customer issue.

16. The system of claim 11, wherein the operations further comprise:
evaluating the Boolean values to identify a network equipment issue with network equipment; and
updating records for user equipment connected to the network equipment, wherein the records are updated to specify the network equipment issue as a user equipment issue condition.

17. The system of claim 11, wherein the operations further comprise:
evaluating the Boolean values to identify a plurality of user equipment with issues during a timeframe; and
identifying network equipment as having a network equipment issue based upon the plurality of user equipment being connected to or attempting to connect to the network equipment during the timeframe.

18. A non-transitory computer-readable medium storing instructions that when executed by one or more processors facilitate performance of operations comprising:
retrieving data associated with operation of a network;
converting the data into a series of Boolean values, wherein a Boolean value represents whether a condition is met or not;
interpreting the series of Boolean values to identify issues associated with the network;
grouping the issues into clusters based upon similarity of the issues;
assigning root causes to each of the clusters, wherein a root cause assigned to a cluster corresponds to a cause of an in issue represented by the cluster; and
executing an action for resolving the root cause of the issue.

19. The non-transitory computer-readable medium of claim 18, wherein the operations further comprise:
executing the action to at least one of trigger a workflow, update a map with an indication of the issue, automatically process a service ticket, automatically process and close the service ticket, send a message to a customer of the issue, generate a report, or perform crowd source troubleshooting.

20. The non-transitory computer-readable medium of claim 18, wherein the operations further comprise:
executing the action to provide a recommendation of tasks to perform to address issues identified from the series of Boolean values, wherein the recommendation specifies priorities for the tasks.
